(19) United States
(12) Patent Application Publication
(10) Pub. No.: US 2024/0146013 A1
(43) Pub. Date: May 2, 2024

(54) METHOD AND ARRANGEMENT FOR INCREASING THE BEAM QUALITY AND STABILITY OF AN OPTICAL RESONATOR

(71) Applicants: Fraunhofer-Gesellschaft zur Förderung der angewandten Forschung e.V., München (DE); Karlsruher Institut für Technologie, Karlsruhe (DE)

(72) Inventors: Marc EICHHORN, Ettlingen (DE); Christelle KIELECK, Ettlingen (DE)

(73) Assignees: Fraunhofer-Gesellschaft zur Förderung der angewandten Forschung e.V., München (DE); Karlsruher Institut für Technologie, Karlsruhe (DE)

(21) Appl. No.: 18/278,185

(22) PCT Filed: Mar. 3, 2022
(86) PCT No.: PCT/EP2022/055400

§ 371 Date: Aug. 22, 2023

(30) Foreign Application Priority Data
Mar. 4, 2021 (DE) 10 2021 105 188.6

(51) Int. Cl. H01S 3/08

(52) U.S. Cl. CPC H01S 3/08059; H01S 3/08054; H01S 3/08072

(57) ABSTRACT

A method and arrangement for compensation of thermally induced depolarising effects in an optical resonator employ a retroreflective prism effecting multiple instances of total internal reflection as one end mirror of the resonator. The retroreflective prism has a first roof edge face pair made of two perpendicular roof edge faces and at least one second face with total internal reflection or a second roof edge face pair. Laser radiation entering parallel to the optical axis of the resonator undergoes total internal reflection through an angle α at the second face or the second roof edge face pair before it undergoes total internal reflection at the first roof edge face pair and emerges again from the retroreflective prism in a manner parallel to the optical axis of the resonator following another instance of total internal reflection at the second face or the second roof edge face pair.

### TECHNICAL APPLICATION AREA

The present invention relates to a method for improving the stability of an optical resonator and increasing beam quality. It is designed to compensate for the thermally induced depolarising effects in an optical resonator, in particular a birefringence occurring in an active medium of a laser resonator, to improve the beam quality in an optical non-linear process in an optical resonator by image rotation, and optionally for adjustment of the degree of output coupling from an optical resonator via a polariser. The invention also relates to an optical resonator designed according to the method.

For applications of solid state lasers or optical-parametric oscillators (OPO) in difficult environmental conditions, for example in military operations, hard-wearing, stable solutions are required for the optical resonators. At the same time, thermal effects take place with higher laser outputs, which must be at least partially compensated. In the field of optronic countermeasures with lasers, laser material processing or in laser illuminators and target markers, for example, the use of isotropic laser media such as YAG results in stress-induced birefringence, particularly with higher output. In polarised lasers, this leads to a deterioration of beam quality, and possibly even optical destruction of internal laser components. In the field of non-linear converters, optical parametric oscillators for example, when using large beam diameters such as are needed to generate high outputs and pulse energies to avoid optical damage thresholds, an effect occurs during critical phase matching according to which the quality of the beam in the non-critical plane is worsened compared with the critical plane.

### PRIOR ART

In lasers for military applications, retroreflectors which have a self-adjusting property due to retroreflection and can therefore be of robust construction are often used as resonator end mirrors. In order to solve the problem described above, solutions are known in which this construction was combined with other methods. However, the previously known methods increase the complexity and number of the components used, and thus reduce the reliability of the lasers.

In order to compensate birefringence in the active medium of a laser resonator, the following solutions are known at present. Use of a 90° quartz rotator between two substantially identically pumped laser media is described in S. Konno et al., Appl. Phys. Lett. 70 (20), 2650 (1997). With this construction, the depolarisation when passing through the first medium is cancelled by switching the two polarisation directions in the second medium. For this, however, two distinct laser media are needed, which also have to be pumped practically identically. The greater number of components has the effect of increasing likelihood of failure, the costs and the complexity of the arrangement.

J. Sherman, Applied Optics, Vol. 37, No. 33, 7789 (1998) describes an arrangement in which a 45° Faraday rotator is inserted between a pumped laser medium and a retroreflector, by which the depolarisation adopted by the laser beam in the forward direction is cancelled by the active medium in the backward pass. However, the output limit of the Faraday rotator imposes an output restriction on the laser assembly.

A further option for birefringence compensation consists in the use of a λ/4 retardation plate between a pumped laser medium and a specially coated Porro retroreflector, such as is described for example in J. Richards, Applied Optics, Vol. 26, No. 13, 2514 (1987). In this context, the depolarisation adopted by the laser beam in the forward direction through the active medium is cancelled by the combined effect of λ/4 plate and image inversion in the backward pass. The Porro retroreflector must be adapted with a special dielectric coating in such manner that a phase shift does not take place between the two polarisations (“Zero-Phase-Shift-Porro”). This solution therefore requires a specific coating of the Porro retroreflector, which entails higher costs. Moreover, slight deviations and tolerances in the layer thicknesses of this coating can allow residual depolarisation.

U.S. Pat. No. 4,408,334 A describes the use of a specially fabricated retardation plate with a specifically adapted retardation between a pumped laser medium and an uncoated Porro retroreflector. The depolarisation adopted by the laser beam in forward direction through the active medium is to be cancelled by the combined effect of retardation plate, phase shift of the Porro retroreflector and image inversion in the backward pass. However, this solution too entails additional costs due to the retardation plate which must be manufactured specially for this application, since it does not correspond to the standard.

Various approaches are also known for compensation of the beam quality effects of OPOs. A. V. Smith et al., JOSA B, Vol. 19, No. 8, 1801 (2002) suggest compensating for the deterioration in the beam quality of an optical parametric process in the non-critical plane compared with the critical plane by driving the OPO crystal in a ring resonator, which produces an image rotation of 90° per round trip. In this way, the beam quality improving effect of the OPO crystal acts alternately on both lateral dimensions of the beam during each round trip. However, this solution requires a special resonator structure, manufactured with extremely high precision, with corresponding loss of design flexibility. The ring design has the effect of increasing the resonator length, which in turn raises the threshold.

DE 10 2011 115 543 B4 suggests a ring resonator with six mirrors arranged in three different planes in order to produce an image rotation that only equals 360° after at least five round trips. An improvement of beam quality is also achieved with a resonator of such kind. In this case too, however, the same drawbacks are encountered as for the solution presented above.

A. V. Smith et al., JOSA B, Vol. 18, No. 5, 706 (2001) suggest compensating the deterioration of the beam quality of an optical parametric process in the non-critical plane compared with the critical plane by driving the OPO crystal in a standing wave resonator which produces an image rotation of 90° per round trip. For this, two Porro prisms are used as resonator-reflectors that are offset by exactly 45° with respect to one another. In this way, the beam quality improving effect of the OPO crystal acts alternately on both lateral dimensions of the beam during each round trip. Since the polarisation must not be changed by the Porro prisms in this solution, a λ/2 plate must also be implemented to rotate the polarisation into an eigenpolarisation plane of the prism. In addition, methods for frustrated total internal reflection that are not explained in greater detail are required in order to couple the laser radiation out, which is technically demanding and complex.

The problem addressed by the present invention is that of describing a method and arrangement that simply and reliably facilitate a compensation of a birefringence occurring in the active medium of a laser resonator or a deterioration of the beam quality of a non-linear process in an optical resonator without any additional phase-shifting coatings or the use of more components.

### SUMMARY OF THE INVENTION

The problem is solved with the method and the arrangement according to Claims 1 and 4. Advantageous variants of the method and the arrangement constitute the objects of the dependent claims or may be discerned from the following description and the application examples.

In the suggested method and the suggested arrangement, a specially designed retroreflective prism effecting multiple instances of total internal reflection is used as at least one of the elements forming the optical resonator or laser resonator that reflect the laser radiation. The construction and alignment of this prism, in particular the number and orientation or angle of intersection of the faces of the prism that induce total internal reflection of the laser radiation are chosen—depending on the application also in combination with the alignment and position of an additional retardation optical unit, an additional retroreflective prism or a polariser—according to the definition of the respective task, for example birefringence compensation, image rotation in an OPO resonator or specific coupling out with a minimal number of components. With the suggested method and the suggested arrangement, full use is made of the special phase shift properties of this prism.

The suggested arrangement represents an optical resonator, which is formed in known manner from multiple elements that reflect laser radiation and function as resonator mirrors. In this context, the optical resonator includes at least one active or optically non-linear medium and may be embodied as a standing wave resonator, for example. At least one of the elements reflecting the laser radiation is formed in the suggested resonator by a retroreflective prism that effects multiple instances of total internal reflection, and in the simplest variant thereof has a first roof edge face pair including two roof edge faces arranged perpendicularly to one another and a second face which is totally internally reflective or a second roof edge face pair consisting of two roof edge faces arranged perpendicularly to one another. The first roof edge face pair forms the retroreflective part of retroreflective prism. In this context, the first roof edge face pair and the second face or the second roof edge face pair are arranged such that laser radiation entering the retroreflective prism parallel to the optical axis of the resonator undergoes total internal reflection at an angle α at the second face or the second roof edge face pair before undergoing total internal reflection at the first roof edge face pair, is retroreflected in the case of a standing wave resonator, and following another total internal reflection at angle α on the second face or the second roof edge face pair exits the retroreflective prism again parallel to the optical axis of the resonator. In this context, the (second) roof edge formed by the two roof edge faces of the second roof edge face pair arranged perpendicularly to one another lies in the plane of incidence of the laser radiation that is reflected at this roof edge face pair. In this context, for the purposes of the present patent application, the optical axis of the resonator is understood to be the axis or—for a ring resonator—combination of axes on which the laser radiation circulates in the resonator.

With the suggested method and the suggested arrangement, angle α is chosen from s- and p-polarisation (s: vector of the electrical field strength perpendicularly to the plane of incidence; p: vector of the electrical field strength parallel to the plane of incidence) according to the desired phase shift effect. Depending on the respective application and the effect to be produced, the retroreflective prism effecting multiple instances of total internal reflection is designed in such manner that the first roof edge formed by the roof edge faces of the first roof edge face pair is aligned either perpendicularly or parallel to the plane of incidence of the laser radiation at the second face or the second roof edge face pair, or at a different angle β to this plane of incidence, wherein 0°<β<90°.

Compared with a conventional Porro prism, which only includes the roof reflector, that is to say the first roof edge face pair, the total internal reflection that takes place additionally at the second face or the second roof edge face pair on the outward and the return path allows an additional phase shift between the originally incident s- and p-polarisation after retroreflection that is freely adjustable by selection of the angle of reflection a. This in turn enables further properties, such as integration of the phase shifts of additionally required retardation plates in a single component or varying the prism-intrinsic phase shifts. In this context, a Porro prism is understood to be a prism that includes only the roof reflector and no other faces that induce total internal reflection.

By using the second roof edge face pair instead of the second face, it is possible to achieve retroreflective parallelism not only in one, but in both transverse axes with the prism.

In a further development of the suggested arrangement and the suggested method, the retroreflective prism effecting multiple instances of total internal reflection is designed in such manner that it includes a further face with total internal reflection. This third face is arranged such that the laser radiation entering the retroreflective prism undergoes total internal reflection between the second roof edge face pair and the first roof edge face pair at an angle α2 on the third face. The angle α2 provides a further adjustment parameter for the phase shift between s- and p-polarisation.

In one variant of the optical resonator, in particular as a laser resonator with an active medium, the angle α and optionally the angles α2 and/or β are selected such that the birefringence which occurs during proper operation of the laser—depending on the configuration either without or in combination with a quarter-wave retardation optical unit in the resonator—is compensated by the retroreflective prism with no additional phase-shifting coating. The angles that are required for the phase shift that is to be effected may be calculated using the Fresnel equations, taking into account the available prism materials which enable a total internal reflection of the laser radiation at angles α and optionally α2, and at the roof edge face pairs. In one variant of the optical resonator, in particular with an optical non-linear medium for an optical non-linear process, for example in the form of an OPO, at least one further retroreflective prism is used as a mirror in the resonator, with a standing wave resonator as end mirror at the other end of the resonator. The further retroreflective prism may be a retroreflective prism that effects multiple instances of total internal reflection according to the present invention, or also just a simple Porro prism. In this context, the angles of rotation of both prisms about the optical axis of the resonator are set such that an image rotation per round trip is achieved by which the deterioration of the beam quality, as may occur in particular in an optical non-linear process, is compensated, in this case too without additional phase-shifting coating of the prisms. In such as case, an image rotation per round trip in an angular range from 60° to 150° is particularly advantageous. An arrangement of such kind for image rotation may also be used advantageously in an optical resonator with an active medium.

The suggested method and the suggested arrangement thus enable a more robust, simpler solution for compensating the birefringence in a laser resonator or the deterioration of beam quality in an OPO. In particular, the suggested solution does not require any additional phase-shifting coating of the prism, and also no specially designed retardation elements—that is to say differing from standard elements. Rather standard retardation plates can be used as needed. The method and the arrangement are suitable in particular for lasers and non-linear converters with optical resonators, in particular for compact and robust construction for platform-mounted laser systems, for example in military application.

### BRIEF DESCRIPTION OF THE DRAWINGS

In the following text, the suggested method and the suggested arrangement will be explained again, in greater detail, with reference to application examples in conjunction with the drawings. In the drawings:

FIG. 1 shows a first example of a variant of the retroreflective prism used in the suggested method and the suggested arrangement;

FIG. 2 shows a second example of a variant of the retroreflective prism used in the suggested method and the suggested arrangement;

FIG. 3 shows a third example of a variant of the retroreflective prism used in the suggested method and the suggested arrangement;

FIG. 4 shows a fourth example of a variant of the retroreflective prism used in the suggested method and the suggested arrangement; and

FIG. 5 shows a fifth example of a variant of the retroreflective prism used in the suggested method and the suggested arrangement.

### WAYS OF IMPLEMENTING THE INVENTION

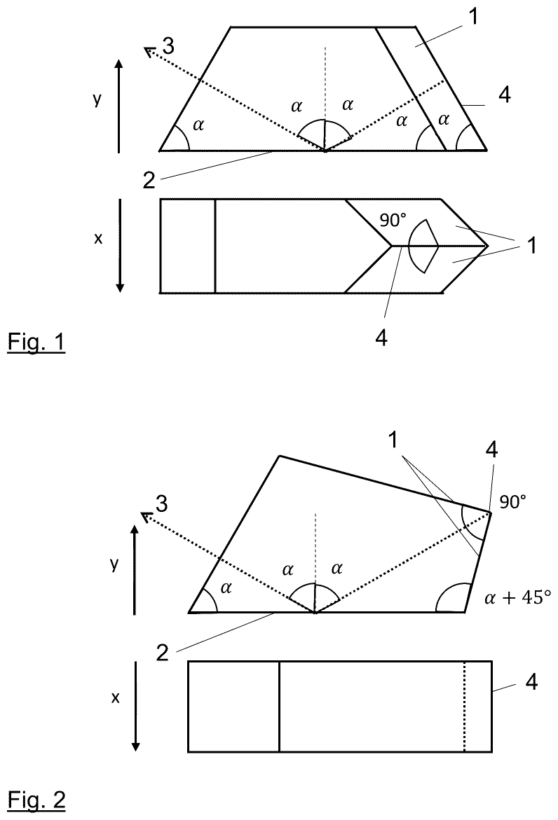

In the suggested method and the arrangement designed for performance of the method, specially constructed retroreflective prisms are used, consisting of a Porro-like 90° roof retroreflector, also called a first roof edge face pair in the present patent application, and at least one further face that effects total internal reflection. FIG. 1 shows a side view (top diagram) and a plan view (bottom diagram) of a first example of an embodiment of such a prism. This prism includes the first roof edge face pair 1 as the retroreflective part, and a second face 2 that effects total internal reflection, hereafter also referred to simply as second face 2, as indicated in the top part of FIG. 1. The first roof edge face pair 1 and the second face 2 are arranged and aligned in such manner that a laser beam 3 entering the retroreflective prism parallel to the optical axis of the resonator first undergoes total internal reflection at an angle α on the second face 2, and then reaches the first roof edge face pair 1 perpendicularly, where it is retroreflected and undergoes total internal reflection at angle α again on the second face 2, before it exits the retroreflective prism again, parallel to the optical axis of the resonator. This construction assures a reflection-polarisation sequence s-p-p-s or p-s-s-p for laser radiation that is polarised perpendicularly (s) or parallel (p) to the plane of incidence on the second face 2. This means that during the total of four total internal reflections until its return upon exiting the prism, in the course of the respective individual total internal reflections an “s” polarised incident field component first undergoes a phase shift according to “s” on face 2, then a total of two phase shifts according to “p” on the faces 1, and finally another a phase shift according to “s” polarised laser radiation on face 2. For a field component that is incident as “p”, the phases that are passed through in this sequence are reversed, i.e. first “p”, then “s” twice, and finally “p” again.

In the variant of FIG. 1, the roof edge 4 formed by the first roof edge face pair 1 is orientated parallel to the plane of incidence of the laser beam 3 on the second face 2. In another variant, as illustrated in FIG. 2, this roof edge 4 is rotated through 90° compared with the alignment of FIG. 1, so that it extends perpendicularly to the plane of incidence of the laser beam 3 on the second face 2. In this context, FIG. 2 again shows a side view of the retroreflective prism in the top diagram, and a plan view in the bottom diagram. In this variant, a reflection-polarisation sequence of s-s-s-s or p-p-p-p is obtained for laser radiation polarised perpendicularly or parallel to the plane of incidence on the second face 2.

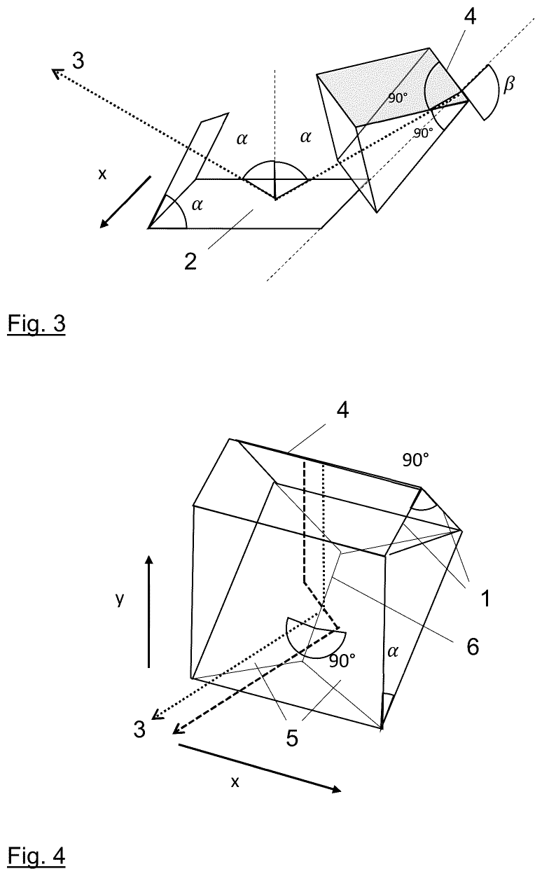

The first roof edge 4 may also be orientated at another angle β (0°<β<90°) with respect to the plane of incidence of the laser radiation on the second face 2, as is indicated in the perspective diagram of individual components of the prism in FIG. 3. This angle β represents an additional parameter for influencing the phase shift between the two polarisations.

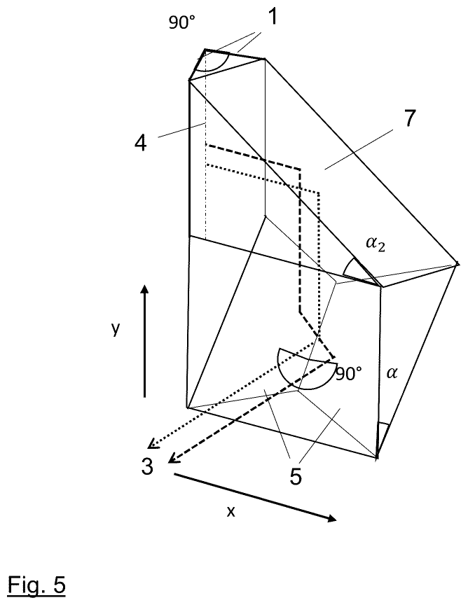

FIGS. 1 to 3 show the beam centre of the laser beam 3 reflected back on itself, in the following FIGS. 4 and 5, the path of a beam portion of the laser beam that is reflected back on itself propagating outside of the beam centre (which here passes over both roof edges) is also shown in each case.

FIG. 4 shows a further possible variant of the retroreflective prism used in the suggested optical resonator and the suggested method. In this example, the second face is replaced with a second 90° roof edge, referred to in the present patent application as second roof edge face pair 5. In this way, the retroreflection axis of the retroreflective first roof edge face pair 1 is rotated through an angle of 90°, as is also indicated in the perspective representation of FIG. 4. Here, the roof edge 6 formed by the second roof edge face pair 5 defines the plane of incidence of the laser beam 3 upon reflection at this roof edge face pair. By using this further roof instead of a planar reflection plane for internal redirection through 90°, a retroreflective prism effecting 6-fold total internal reflection is obtained. In this situation, the polarisation planes are swapped at the first two reflections on the first roof reached (second roof edge face pair 5), with the result that the phase shifts of the total internal reflections at this roof edge face pair 5 compensate one another mutually. This also occurs with the last two reflections at this roof edge face pair 5 before the retroreflected beam exits the prism. Thus, this prism behaves like a normal Porro prism as regards its phase shift, originating solely from the reflections at roof edge face pair 1. However, retroreflection parallelism is achieved not just in one, but in both transverse axes.

Finally, FIG. 5 shows a perspective view of a further exemplary embodiment of a retroreflective prism such as may be implemented in the suggested method and/or the suggested optical resonator. In this prism, compared with the variant of FIG. 4, an additional reflective plane is also interposed between the two roof structures by the third face 7 effecting total internal reflection. The laser beam 3 is reflected on this face through an angle α2. By using this further planar reflection plan for internal redirection through preferably 90°, as represented in FIG. 5, a retroreflective prism effecting 8-fold total internal reflection is obtained. In this situation, the polarisation planes are swapped at the first two reflections on the first roof reached (second roof edge face pair 5), with the result that the phase shifts compensate one another mutually. This also occurs with the last two reflections at this second roof edge face pair 5 before the retroreflected beam exits the prism. α2 is particularly advantageously chosen to be exactly 45° since the phase shifts due to the reflections at the additional plane (third face 7) on the outbound and return paths and due to the retroreflective roof (first roof edge face pair 1) then cancel each other out as well. Thus, like the prism of FIG. 1 this prism with α=45° for α2=45° returns no overall phase difference, but retroreflection parallelism is achieved not just in one, but in both transverse axes.

In a first application example, the suggested method for birefringence compensation is used in a laser resonator. For this purpose, a retroreflective prism effecting 4-fold or 8-fold total internal reflection is used as one of the resonator end mirrors, as represented in FIG. 1 or FIG. 5. In this context, the angles α and α2 each have a value of 45°. In addition, a quarter-wave retardation optical unit (e.g. λ/4 plate) is used in the laser resonator, the fast axis of said unit being offset by 45° relative to the roof edge 4 projected onto the quarter-wave retardation optical unit along the beam path in retroreflection, i.e. the image inversion axis. With the same number of s- and p-total internal reflections, each with a 45° angle of incidence in the retroreflective prism, this prism produces the same total phase shift for each polarisation direction, regardless of the prism material, thus behaving like a “Zero-Phase-Shift-Porro”. Consequently, laser radiation with a polarisation along the +/−45° line, i.e. along the fast or the slow axis of the quarter-wave retardation optical unit does not undergo a phase change because of this, but it is rotated 90° by the image inversion of the retroreflective prism. Laser radiation with a polarisation incident on the prism along the 0° or 90° line, i.e. parallel or orthogonal to the roof edge 4 projected onto the prism inlet face in retroreflection of the beam path, i.e. along the axis extending at 0° or 90° to the image inversion axis of the prism, is converted into circularly polarised laser radiation by the quarter-wave retardation optical unit. Since retroreflection through the prism does not bring about a polarisation change in this case, during the second pass through the quarter-wave retardation optical unit the polarisation of this laser radiation is converted to a linear polarisation rotated through 90° with respect to the original polarisation. In this way, linearly polarised laser radiation is retroreflected with a 90° rotation regardless of the orientation of its polarisation, with the result that the birefringence is compensated with a double pass through the laser medium.

With this variant, therefore, unlike a “Zero-Phase-Shift-Porro” according to the prior art described earlier, a material-dependent special coating is not needed for birefringence compensation. Consequently, the influence of the coating tolerances on the phase shift and the wavelength dependency of the phase shift does not need to be considered. At the same time, with this variant any prism material in which total internal reflection occurs under a 45° internal angle of incidence is suitable for selection. This offers the freedom to choose the prism material on the basis of minimal absorption in the spectral range of the laser radiation or on the basis of a particularly high optical damage threshold, which in particular is not reduced by an additional coating on the total internal reflection side.

In a second application example, a retroreflective prism according to FIG. 3 is used as one of the resonator end mirrors in a laser resonator for birefringence compensation. This prism delivers the same effect as in the first application example when angles α and β of this prism are selected in the vicinity of +/−45° and a quarter-wave retardation optical unit is not used in the resonator. In this context, the exact values of angles α and β are obtained, depending on the refractive index of the prism material, from the condition that the phase difference Δφ between the p- and s-total internal reflection relative to face 2 must be

$$Δφ = - 2 {cos}^{- 1} ( \frac{1}{\sqrt{2}} cos \frac{{Δφ}_{D}}{2} ) ,$$

and the angle of rotation

$$β = \frac{1}{2} {sin}^{- 1} ( \frac{1}{\sqrt{2} sin \frac{{Δφ}_{D}}{2}} )$$

is selected. In such a case, Δφ_{D} is the phase difference that arises from the total internal reflection on the roof, that is to say the first roof edge face pair. With this prism, it is advantageous to use highly refractive materials, because then both angles α and β are close to 45°.

In a third application example, a retroreflective prism according to FIGS. 1 to 5 is used for adjustment of the degree of output coupling of laser radiation in a laser- or OPO resonator. In this case, the retroreflective prism is again used as an end mirror of the optical resonator. A polariser is arranged in front of this retroreflective prism in the resonator and serves to partially couple the laser radiation out. By setting an angle of rotation ϕ of the prism (about the optical axis of the resonator) or choosing angles α and β or α and α2 appropriately, the degree of output coupling can be adjusted, as this has the effect of determining the relative phasing between the polarisations, and thereby effecting a change in the polarisation state of the retroreflected laser radiation. The component of the retroreflected laser radiation that is polarised perpendicularly to the incident polarisation from the polariser is coupled out as the output laser beam.

In a fourth application example, a retroreflective prism according to FIGS. 1 to 5 is used to compensate the deterioration in the beam quality of an optical parametric process in a laser- or OPO resonator. In this case, the retroreflective prism is again used as an end mirror on one end of a standing wave resonator. Optionally, a polariser may be arranged between said prism and the non-linear medium for the purpose of partially coupling out the laser radiation. By setting an angle of rotation ϕ of the prism (about the optical axis of the resonator), the degree of output coupling can now (optionally) be adjusted and at the same time a mirroring of the transverse beam image about an axis inclined by ϕ with respect to the vertical can be produced. By coupling with a further retroreflective prism effecting multiple instances of total internal reflection or with a simple Porro prism as end mirror at the other end of the resonator, producing a vertical image mirroring in the retroreflection, for example, the entire beam image is rotated by 2ϕ per round trip.

When using prisms with only one 90° roof, arrangements in which the image mirroring axes of both prisms are offset significantly, ideally >30° with respect to each other, are particularly advantageous. This allows the self-stabilising retroreflective property of the prisms in a plane to act on both transverse axes of the resonator, resulting in a sturdy construction that is not sensitive to adjustment. If prisms effecting 6-fold or 8-fold instances of total internal reflection, as shown in FIG. 4 or FIG. 5, the image mirroring axes of both prisms can be in any orientation with regard to the self-stabilising retroreflective property, since each prism itself already exercises a stabilising effect in both axes. In this context, it is particularly advantageous if the image rotation of 2ϕ per round trip that takes place is chosen to be in an angular range from 60° to 150°, since this results in a rapid correlation of the transverse beam phases in a few round trips, and consequently to good beam quality.

The suggested method affords improved control over the phase differences when passing through retroreflective prisms in optical resonators. This enables retroreflective prisms with specific phase difference to be produced without the use of additional phase-shifting coatings. Consequently, they can also be used over wider wavelength ranges, as the material dispersion of conventional optical media typically has lower wavelength dependence relative to the phase shift than are produced by specific coatings. Retroreflectors may be created which have a stabilising effect in both transverse axes and have none of the polarisation changing disadvantages of triple mirror reflectors. By suitable arrangement with retardation optical units in the resonator, it is possible to obtain a simple, compact and robust representation of birefringence compensation. By suitable arrangement in the resonator, a simple, compact and robust representation of any image rotation of the beam image circulating may also be enabled in a linear resonator, wherein—if desired—coupling out via polarisation can be adjusted independently thereof with retardation optical units.

### LIST OF REFERENCE NUMERALS

1 first roof edge face pair (90° roof)
2 second face
3 incoming or exiting laser radiation
4 first roof edge
5 second roof edge face pair (90° roof)
6 second roof edge
7 third face

1. A method of operating an optical resonator, the method comprising:
at least one of compensating thermally induced depolarising effects in the optical resonator; and
generating a resonator-internal image rotation, the optical resonator including a plurality of elements reflecting laser radiation including a retroreflective prism configured to effect multiple instances of total internal reflection, the retroreflective prism including
a first roof edge face pair effecting total internal reflection, consisting of two roof edge faces arranged perpendicularly to one another as a retroreflective part, and
a second face effecting total internal reflection or a second roof edge face pair effecting total internal reflection, the second roof edge face pair consisting of two roof edge faces arranged perpendicularly to one another in such manner that laser radiation entering the retroreflective prism parallel to an optical axis of the optical resonator undergoes total internal reflection at an angle α on the second face or the second roof edge face pair before undergoing total internal reflection on the first roof edge face pair, and after a further total internal reflection at the angle α on the second face or the second roof edge face pair exits the retroreflective prism parallel to the optical axis of the resonator again, wherein
the compensating of the thermally induced depolarising effects is effected through the arrangement of the faces in the retroreflective prism that effect total internal reflection and alignment of the retroreflective prism relative to the optical axis of the resonator, and
the generating the resonator-internal image rotation is effected through the arrangement of the faces in the retroreflective prism that effect total internal reflection and alignment of the retroreflective prism relative to the optical axis of the optical resonator in combination with a further retroreflective prism.

2. The method according to claim 1, wherein the optical resonator further includes a laser resonator, and the method further comprises compensating a birefringence that occurs in an active medium of the laser resonator.

3. The method according to claim 1, further comprising:
compensating a deterioration of a beam quality in an optical non-linear process in the optical resonator.

4. An optical resonator for laser radiation comprising:
a plurality of elements reflecting the laser radiation; and
at least one active or optical non-linear medium,
wherein at least one of the plurality of elements is a retroreflective prism that effects multiple instances of total internal reflection, the retroreflective prism including
a first roof edge face pair effecting total internal reflection, consisting of two roof edge faces arranged perpendicularly to one another as a retroreflective part, by which the first roof edge is formed, and
a second face effecting total internal reflection or a second roof edge face pair effecting total internal reflection, the second roof edge face air consisting of two roof edge faces arranged perpendicularly to one another by which a second roof edge is formed,
the first roof edge face pair and the second face or the second roof edge face air being arranged in such manner that laser radiation entering the retroreflective prism parallel to an optical axis of the optical resonator undergoes total internal reflection at an angle α on the second face or the second roof edge face pair before undergoing total internal reflection on the first roof edge face pair, and after a further total internal reflection at the angle α on the second face or the second roof edge face pair exits the retroreflective prism parallel to the optical axis of the optical resonator again.

5. The optical resonator according to claim 4, further comprising a retardation optical unit.

6. The optical resonator according to claim 4, further comprising a Porro prism or a further retroreflective prism that effects multiple instances of total internal reflection.

7. The optical resonator according to claim 4, wherein the first roof edge is aligned vertically to a plane of incidence of the laser radiation on the second face or the second roof edge face pair.

8. The optical resonator according to claim 4, wherein the first roof edge is aligned parallel to a plane of incidence of the laser radiation on the second face or the second roof edge face pair.

9. The optical resonator according to claim 4, wherein the first roof edge is aligned at an angle β to a plane of incidence of the laser radiation on the second face or the second roof edge face pair, wherein 0°<β<90°.

10. The optical resonator according to claim 4, wherein the retroreflective prism has a third face that effects total internal reflection, the third face being arranged such that the laser radiation entering the retroreflective prism undergoes total internal reflection between the second roof edge face pair and the first roof edge face pair at an angle α2 at the third face.

11. The optical resonator according to claim 10, wherein the first roof edge is aligned at an angle β to a plane of incidence of the laser radiation on the third face, wherein 0°<β<90°.

12. The optical resonator according to claim 10, wherein the first roof edge is aligned vertically to a plane of incidence of the laser radiation on the third face.

13. The optical resonator according to claim 10, wherein the first roof edge is aligned parallel to a plane of incidence of the laser radiation on the third face.

14. The optical resonator according to claim 8, further comprising:
an active medium and a quarter-wave retardation optical unit with one fast and one slow axis, wherein the angles α and optionally α2 are 45°±5°, and the fast axis of the quarter-wave retardation optical unit is aligned at 45°±5° to a plane of incidence of the laser radiation on the second face or the second roof edge face pair.

15. The optical resonator according to claim 9, further comprising:
an active medium, wherein the angles α and β are adjusted within a range of 45°±20°.

16. The optical resonator according to claim 4, further comprising:
an active or optical non-linear medium; and
a Porro prism or a further retroreflective prism, wherein
the retroreflective prism is rotated through an angle of rotation ϕ about the optical axis of the optical resonator, by which a mirroring of a transverse beam image of the laser radiation inclined by the angle ϕ relative to the vertical axis is created upon reflection at the retroreflective prism, and the Porro prism or the further retroreflective prism effects a further mirroring of the transverse beam image.

17. The optical resonator according to claim 16, wherein the retroreflective prism and the Porro prism or the further retroreflective prism are arranged such that an image rotation of the transversal beam image through an angle in an angular range from 60° to 150° is effected for each round trip of the laser radiation in the optical resonator.

18. The optical resonator according to claim 4, further comprising a polariser for partial coupling out of the laser radiation.

19. The method according to claim 1, wherein the optical resonator further includes a retardation optical unit.

20. The optical resonator according to claim 15, wherein the angle α2 has a value of 45°±20°.
